(19) United States
(12) Patent Application Publication
(10) Pub. No.: US 2007/0150137 A1
(43) Pub. Date: Jun. 28, 2007

(54) MOBILE MILEAGE MANAGER FOR EXPENSE REIMBURSEMENT

(75) Inventor: Kerry Graham, Raleigh, NC (US)

Correspondence Address: MOORE AND VAN ALLEN PLLC FOR SEMC, P.O. BOX 13706, 430 DAVIS DRIVE, SUITE 500, RESEARCH TRIANGLE PARK, NC, 27709, US

(73) Assignee: SONY ERICSSON MOBILE COMMUNICATIONS AB, Lund (SE)

(21) Appl. No.: 11/164,979

(22) Filed: Dec. 13, 2005

(51) Int. Cl. G06F 19/00

(52) U.S. Cl. 701/35

(57) ABSTRACT

Described is a means for automatically tracking automobile mileage data on a computerized mileage manager module and wirelessly transmitting it to a mobile basestation or other external receiving device. The mileage manager module is coupled with an odometer and uses an operator interface/display to present data to and receive data from the driver. Upon completion of an automobile business trip a trip mileage file is created that can be wirelessly sent via an RF module within the mileage manager module to an external receiver. The RF module can utilize a mobile cellular protocol to communicate directly with a mobile basestation which, in turn, can communicate with a computer server over an IP network connection. Or, the RF module can utilize a short range RF protocol to move trip mileage files to an external device such as a mobile phone or a laptop computer.

### BACKGROUND OF THE INVENTION

The present invention relates to an automated system and method of tracking and reporting accrued mileage on an automobile for purposes of reimbursement. Many individuals are required to use their personal automobiles to perform duties related to their employment. Their employers often reimburse the employee in the form of cash payments corresponding to the number of miles driven for such work related purposes. The reimbursements are generally disbursed following the receipt of a detailed report on the expenses incurred by the employee. The most significant expense is mileage reimbursement. Mileage reimbursement refers to a cash payment for every mile driven for work related purposes. Thus, an employee's automobile expense report will include a section devoted to the number of miles driven. Currently, the employee must log the number of miles driven and manually input that data into an expense report that is submitted for reimbursement. Since the logging of miles driven is, by and large, a manual effort on the part of the employee, there is a greater chance for erroneous calculations leading to an incorrect expense report.

What is needed is an automated system and method of tracking and reporting accrued mileage on an automobile for purposes of reimbursement.

### BRIEF SUMMARY OF THE INVENTION

The present invention provides a method, apparatus, and/or computer program product embodied on a computer readable storage medium that automatically tracks automobile mileage data on a computerized mileage manager module and wirelessly transmits it to a mobile basestation or other external receiving device. The apparatus or mileage manager module is coupled with the automobile's odometer and uses an operator interface and display to present data to and receive data from the automobile driver. The data gathered by the mileage manager module can include mileage data, employee identification data, and task data. Upon completion of an automobile business trip a trip mileage file is created that can be wirelessly sent via an RF module within the mileage manager module to an external receiver. The RF module can utilize a mobile cellular protocol to communicate directly with a mobile basestation which, in turn, can communicate with a computer server over an IP network connection. Or, the RF module can utilize a short range RF protocol, such as for instance, Bluetooth™ to move trip mileage files to devices such as a mobile phone or a laptop computer.

### BRIEF DESCRIPTION OF THE DRAWINGS

FIG. 1 is a block diagram of a sample network topology for tracking and reporting the mileage incurred by an automobile.

FIG. 2 is a flowchart describing a method for tracking and reporting the mileage incurred by an automobile to a computer server.

FIG. 3 is a block diagram of a mileage manager module within an automobile for use with the present invention.

FIG. 4 is a block diagram of a mileage server on a computer network for use with the present invention.

FIG. 5 is a block diagram of a portable mobile communications device that can act as a conduit to pass data between the mileage manager module to the mileage server.

### DETAILED DESCRIPTION OF THE INVENTION

The present invention describes an automated system and method of tracking and reporting accrued mileage on an automobile for purposes of reimbursement.

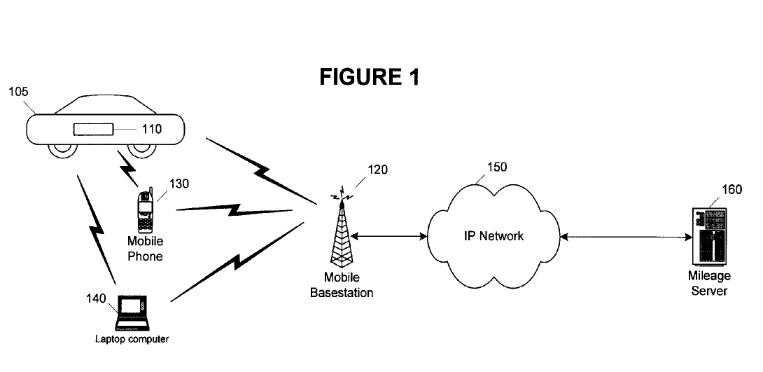

FIG. 1 is a block diagram of a sample network topology for tracking and reporting the mileage incurred by an automobile. The purpose of the present invention is to automatically track and forward mileage incurred by an automobile 105 to a computer server referred to herein as a mileage server 160. The automobile 105 includes a mileage manager module 110. The mileage manager module 110 interfaces with the automobile odometer to record mileage and also includes an RF module capable of transmitting mileage data to an external device. External devices can include, but are not limited to, a portable mobile communications device such as a mobile phone 130 or a laptop computer 140. The mileage manager module 110 can communicate with one of the aforementioned external devices or directly with a mobile basestation 120. The mobile basestation 120 can be communicable with the mileage manager module 110, the mobile phone 130, and/or the laptop computer 140. The mobile basestation can also be coupled with an IP network 150 such as the Internet. The mileage server 160 can also be coupled with the IP network 150. The block diagram of FIG. 1 illustrates an environment that allows data gathered by the mileage manager module to be forwarded back to the mileage server 160 via a variety of transmission paths.

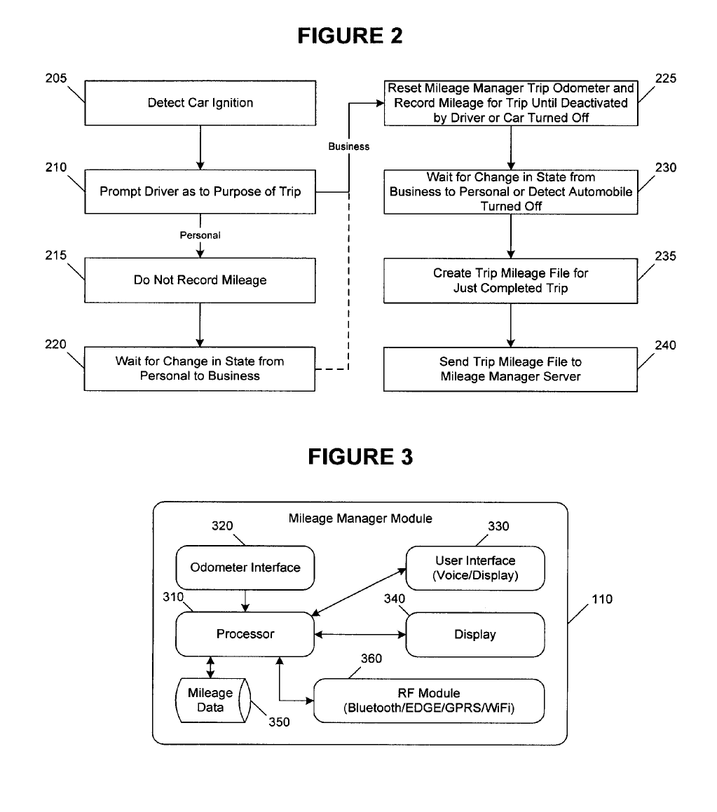

FIG. 2 is a flowchart describing a method for tracking and reporting the mileage incurred by an automobile to a computer server. For purposes of describing the present invention, it is assumed that an automobile is properly equipped with a mileage manager module and an infrastructure is in place that permits the gathering and forwarding of data from the mileage manager module to the mileage server.

When the automobile is started, the ignition is detected by the mileage manager module in block 205. In block 210, the mileage manager module, via a user interface, will prompt the driver as to the purpose of the trip. The driver is given the option of selecting business or personal as the purpose of the trip. If the driver selects “personal” as the purpose of the trip, the mileage manager module will not record the mileage incurred as shown in block 215. In block 220, the mileage manager module will remain inactive until a change in state from personal to business is detected at which time the process will proceed to block 225. If the driver selects “business” as the purpose of the trip, the mileage manager module will, in block 225, reset its internal trip odometer and record the mileage traveled until the automobile is turned off or the driver changes the state from business to personal. Once the mileage manager module detects that the automobile has been turned off or that the driver has caused a change in state from business to personal in block 230, the mileage manager module will log the mileage accrued into a trip mileage file that can also include a time and date stamp in block 235. Shortly thereafter, the mileage manager can automatically (or manually via driver interaction) forward the trip mileage file to the mileage server in block 240. The trip mileage file can include the miles driven for the trip and a driver input reference number. The matter number can associate the trip with a list of tasks that the trip can be reconciled with by the mileage server software. The trip mileage file can also include a time/date stamp indicating when the trip was started and when the trip was completed as well as driver identification data for use by the mileage server software.

FIG. 3 is a block diagram of a mileage manager module within an automobile for use with the present invention. The mileage manager module 110 is primarily responsible for gathering and forwarding mileage data from the automobile to the mileage server. To serve this function the mileage manager includes a processor 310 that receives and processes various data input. An odometer interface 320 is provided that allows the mileage manager module 110 to read the automobile's odometer at selected instances. A user interface 330 is also provided that allows the driver to input data to the mileage manager module 110 and to respond to prompts issued by the mileage manager module 110. The user interface works in conjunction with a display 340 and/or a microphone/speaker (not shown) to present data to the driver and receive data from the driver. The user interface 330 can be graphically driven, textually driven, and/or responsive to voice inputs. The mileage manager module also includes mileage data storage 350 for recording odometer readings and trip mileage files. An RF module 360 is also included that provides a means for transmitting data (trip mileage files) from the mileage manager module 110 to the mileage server. The processor 310 is coupled with and maintains control over the other components that comprise the mileage manager module 110.

The mileage manager module 110 detects when the automobile has been started and prompts the driver, via the user interface 330, as to the purpose of the trip. The prompt can be a text message on the display that asks the driver to select (either by hard key, soft key, or voice response) “Business” or “Personal” as the purpose of this trip. The driver can also be prompted for a task code or matter number to be associated with this trip as well as an employee identification number. This additional data will assist the mileage server in processing mileage submissions by reconciling them with approved business uses and applying them to the proper employee for reimbursement. If the driver fails to make a selection within a given time frame, the mileage manager can make a default selection that can be set to either business or personal. The mileage manager module can be configured to keep a running total of miles accrued for the current trip and show the running total on the display. In addition, the mileage manager module can use either hard or soft keys to provide the driver with the ability to switch the state of the current trip without having to turn off the engine of the automobile. Thus, the mileage manager module 110 can be engaged and disengaged at the touch of a button at any time.

Once a trip has been completed the processor 310 will create and store 350 a trip mileage file for the just completed trip. A trip is defined as completed when two distinct changes of state have occurred. The first is a change from personal to business while the second is a change from business to personal. A change of state may also be recognized when the automobile engine is turned on or off. A fresh prompt is issued to the driver via the user interface 330 each time the automobile engine is turned on. The mileage manager module 110 can be configured to prompt the driver if the new trip is a continuation of the previous trip provided the driver did not affirmatively terminate the previous trip but rather turned the engine off.

At predefined intervals the mileage manager module 110 can upload or transmit its current trip mileage files to the mileage server. This is done using the RF module 360. The RF module can be a short range RF protocol such as Bluetooth™ that depends on another device (such as a mobile phone or laptop computer) to receive and re-convey the data to the mileage server. The RF module 360 can also be of the type that can communicate directly with a mobile basestation via a mobile cellular protocol. There are several mobile cellular wireless protocols and portable equipment capable of longer distance RF transmissions that are known to those of ordinary skill in the art and can be readily implemented into the mileage manager module 110.

Trip mileage files are created and maintained by the processor 310 and stored 350 throughout the day. The mileage manager module 110 can be configured to upload the current trip mileage files on a daily basis automatically or the employee can manually initiate a trip mileage file upload at any convenient time. Once a trip mileage file has been uploaded successfully, it can be marked as such or purged to prevent duplicate sending.

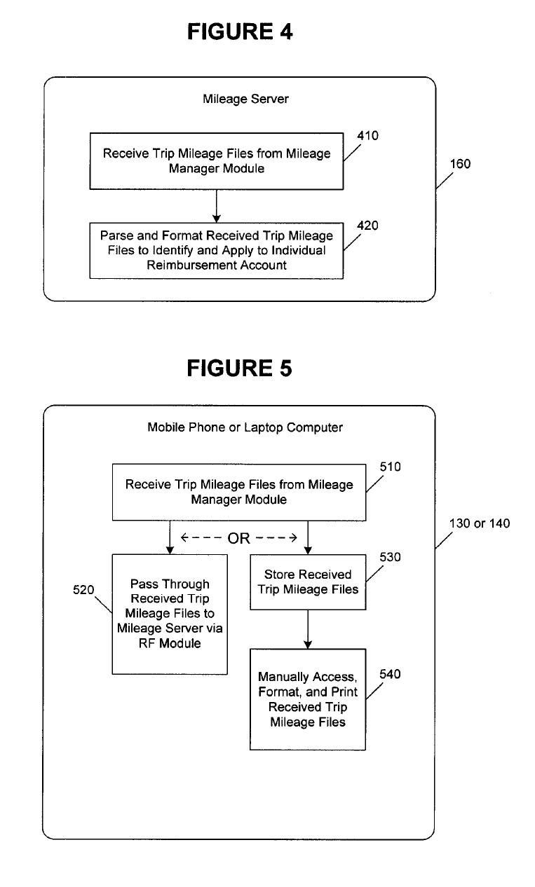

FIG. 4 is a block diagram of a mileage server on a computer network for use with the present invention. The mileage server 160 receives trip mileage files from the mileage manager module on a periodic basis in block 410. Upon receipt of a trip mileage file, software executable by the mileage server 160 will parse and process the trip mileage data in block 420. The task code can be checked against a list of approved task codes to verify that the trip was indeed a business trip. The employee number can be looked up so that the resulting expense reimbursement will be made to the proper employee. The mileage readings can be input into a spreadsheet type program to calculate the amount to be reimbursed on a $ per mile basis. Date and time stamps can be also be processed and included in an expense report.

FIG. 5 is a block diagram of a portable mobile communications device that can act as a conduit to pass data between the mileage manager module to the mileage server. The portable mobile communications device 160 receives trip mileage files from the mileage manager module in block 510. The portable mobile communications device user has options when dealing with the received trip mileage files. One option is to pass through the trip mileage files to the mileage server via its own RF module in block 520. Another option is to store the trip mileage files in block 530 locally on the portable mobile communications device for later action. The trip mileage files can be locally stored either internally on the portable mobile communications device or on a removable media coupled with the portable mobile communications device. Once stored, the portable mobile communications device user can, in block 540, manually access the trip mileage files to format and print them to be submitted in hardcopy form for reimbursement.

In an alternate use or embodiment of the present invention, the automatic recording of mileage and its subsequent transfer to a computer server can be applied to the rental car industry to accurately track mileage without having to spend additional time verifying mileage when a renter returns the car.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method of automatically tracking automobile mileage data on a computerized mileage manager module and transmitting it to a computer server comprising:
determining whether an automobile trip is for business or personal purposes;
recording mileage incurred by automobile if the automobile trip is for a business purpose;
creating a trip mileage file upon completion of the automobile trip that is for a business purpose, wherein the trip mileage file comprises the number of miles driven on the automobile trip that is for a business purpose; and
wirelessly transmitting the trip mileage file.

2. The method of claim 1 wherein the step of determining whether an automobile trip is for business or personal purposes comprises:
prompting the employee to enter the purpose of the current automobile trip via user interface and display means provided on the computerized mileage manager module;
prompting the employee to enter an employee identifier that associates an employee with the automobile trip if it is for a business purpose; and
prompting the employee to enter a task identifier that associates the automobile trip with a specific employer approved task if it is for a business purpose.

3. The method of claim 2 wherein the step of recording mileage incurred by automobile if the automobile trip is for a business purpose comprises:
accessing the odometer of the automobile to read and record the miles on the odometer at the start and end of the automobile trip that is for a business purpose.

4. The method of claim 3 wherein the trip mileage file includes the employee identifier.

5. The method of claim 4 wherein the trip mileage file includes the task identifier.

6. The method of claim 1 wherein the step of wirelessly transmitting the trip mileage file comprises sending the trip mileage file using a mobile cellular protocol.

7. The method of claim 1 wherein the step of wirelessly transmitting the trip mileage file comprises sending the trip mileage file using a short range RF protocol.

8. The method of claim 7 wherein the short range RF protocol is Bluetooth™.

9. The method of claim 7 wherein the short range RF protocol is an 802.11x WiFi protocol.

10. A mileage manager module for tracking and transmitting automobile mileage data comprising:
a processor executing a mileage manager computer program;
an odometer interface coupled with the processor and an automobile odometer such that an odometer reading can be determined when instructed by the mileage manager computer program;
a user interface coupled with the processor for receiving input to be processed by the processor according to the instructions of the mileage manager computer program,
a display coupled with the processor for displaying data and prompts,
storage means coupled with the processor for storing a trip mileage file created by the mileage manager computer program, and
an RF module coupled with the processor for wirelessly transmitting the trip mileage file when instructed by the mileage manager computer program.

11. The mileage manager module of claim 10 wherein the RF module utilizes a mobile cellular protocol to wirelessly transmit the trip mileage file to a mobile basestation.

12. The mileage manager module of claim 10 wherein the RF module utilizes a short range RF protocol to wirelessly transmit the trip mileage file to a nearby wireless transceiver.

13. The mileage manager module of claim 12 wherein the short range RF protocol is Bluetooth™.

14. The mileage manager module of claim 12 wherein the short range RF protocol is an 802.11x WiFi protocol.

15. The mileage manager module of claim 12 wherein the nearby wireless transceiver is a mobile phone.

16. The mileage manager module of claim 12 wherein the nearby wireless transceiver is a laptop computer.

17. A computer program product embodied on a computer readable storage medium for automatically tracking automobile mileage data on a computerized mileage manager module and transmitting it to a computer server, the computer program product comprising:
computer program code for determining whether an automobile trip is for business or personal purposes;
computer program code for recording mileage incurred by automobile if the automobile trip is for a business purpose;
computer program code for creating a trip mileage file upon completion of the automobile trip that is for a business purpose, wherein the trip mileage file comprises the number of miles driven on the automobile trip that is for a business purpose; and
computer program code for wirelessly transmitting the trip mileage file.

18. The computer program product embodied on a computer readable storage medium of claim 17 wherein the computer program code for determining whether an automobile trip is for business or personal purposes comprises:
computer program code for prompting the employee to enter the purpose of the current automobile trip via user interface and display means provided on the computerized mileage manager module;
computer program code for prompting the employee to enter an employee identifier that associates an employee with the automobile trip if it is for a business purpose; and
computer program code for prompting the employee to enter a task identifier that associates the automobile trip with a specific employer approved task if it is for a business purpose.

19. The computer program product embodied on a computer readable storage medium of claim 18 wherein the computer program code for recording mileage incurred by automobile if the automobile trip is for a business purpose comprises:
computer program code for accessing the odometer of the automobile to read and record the miles on the odometer at the start and end of the automobile trip that is for a business purpose.

20. The computer program product embodied on a computer readable storage medium of claim 19 wherein the trip mileage file includes the employee identifier.

21. The computer program product embodied on a computer readable storage medium of claim 20 wherein the trip mileage file includes the task identifier.

22. The computer program product embodied on a computer readable storage medium of claim 17 wherein the computer program code for wirelessly transmitting the trip mileage file comprises sending the trip mileage file using a mobile cellular protocol.

23. The computer program product embodied on a computer readable storage medium of claim 17 wherein the computer program code for wirelessly transmitting the trip mileage file comprises sending the trip mileage file using a short range RF protocol.

24. The computer program product embodied on a computer readable storage medium of claim 23 wherein the short range RF protocol is Bluetooth™.

25. The computer program product embodied on a computer readable storage medium of claim 23 wherein the short range RF protocol is an 802.11x WiFi protocol.
